(19) United States
(12) Patent Application Publication
(10) Pub. No.: US 2013/0254349 A1
(43) Pub. Date: Sep. 26, 2013

(54) SYSTEMS AND METHODS FOR PUBLISHING, MANAGING AND/OR DISTRIBUTING ONE OR MORE TYPES OF LOCAL DIGITAL MEDIA CONTENT TO ONE OR MORE DIGITAL DEVICES

(71) Applicant: Jon Scott Zaccagnino, Bethlehem, PA (US)

(72) Inventor: Jon Scott Zaccagnino, Bethlehem, PA (US)

(73) Assignee: Jon Scott Zaccagnino, Bethlehem, PA (US)

(21) Appl. No.: 13/895,028

(22) Filed: May 15, 2013

Related U.S. Application Data
(63) Continuation-in-part of application No. 12/386,313, filed on Apr. 16, 2009, now Pat. No. 8,447,642.
(60) Provisional application No. 61/045,656, filed on Apr. 17, 2008.

(51) Int. Cl. H04L 29/08

(52) U.S. Cl. CPC H04L 67/32
USPC 709/219

(57) ABSTRACT

Systems and methods distribute geographically relevant local digital media content to one or more digital devices over at least a first digital communication network. The systems and methods determine geographical relevance of local digital media content, with respect to a geographical region associated with the first digital device and/or associated with a consumer utilizing the first digital device, to identify geographically relevant local digital media content. The systems and methods determine a digital media content type of the geographically relevant local digital media and filter the geographically relevant local digital media based on the digital media content type of the geographically relevant local digital media and at least one of the first digital device or a third-party website. The systems and methods distribute filtered geographically relevant local digital media content to the first digital device or the third-party website via the first digital communication network.

### CROSS REFERENCE TO RELATED APPLICATION

This application is a Continuation-In-Part of U.S. patent application Ser. No. 12/386,313, filed on Apr. 16, 2009, which is a non-provisional application claiming the benefit under 35 U.S.C. 119(e) of U.S. Provisional Patent Application No. 61/045,656, filed on Apr. 17, 2008. All of these applications are incorporated herein by reference in their entirety.

### FIELD OF THE DISCLOSURE

The present systems and methods relates in general to Internet-based digital publishing, management and distribution of local digital content and in particular to its automated delivery via a plurality of digital media types. The present systems and methods provide for single entry point publishing, management and distribution of local content over various digital media types on, for example, the Internet. The present systems and methods publish, manage and/or distribute one or more types of digital media content to one or more digital devices over one or more digital communication networks. The one or more digital devices may be a stationary device, portable device, a handheld device, a mobile device or a combination thereof.

### BACKGROUND

Despite the fact that the Internet and World Wide Web have grown in size and popularity it is still too difficult to find local content. Local content represents the majority of the content people use regularly.

There are several challenges that are contributing to this problem:

The vast majority of local content is not available online because the publishing, management and distribution of local content to the plurality of Internet media types is too time and resource consuming.

What is available online is hard to find because it is not location sensitive thus reducing the value of publishing and distributing local content.

Local content on the Internet is not standardized or organized to facilitate the exchange of content amongst all of the local stakeholders who use various terms and descriptions to describe the same thing.

Individuals are having a difficult time managing the deluge of content that they are subjected to daily on the Internet. In addition, they have very little control over of the relevancy of the content delivered via the Internet.

Information authors/owners are having difficulty, due to cost and resource challenges, in maintaining their local content on the Internet which is a major contributor to the lack of local content available.

Information authors/owners are having difficulty, due to technical and time challenges in delivering their local content to those that seek it via the various media types available on the Internet. This is mostly due to the fact that the content is not portable or easily exchanged between media types such as email, websites and web portals without technical expertise.

### SUMMARY

In embodiments, the present systems and methods may distribute geographically relevant local digital media content to one or more digital devices over at least a first digital communication network. The present systems and methods may provide a local digital media content distribution system comprising at least a first digital device and a database connected to and in communication with each other via the first digital communication network, wherein local digital media content is stored within the database. The present systems and methods may determine geographical relevance of the local digital media content, with respect to a geographical region associated with the first digital device and/or associated with a consumer utilizing the first digital device, to identify geographically relevant local digital media content, wherein the geographically relevant local digital media content is geographically relevant with respect to the geographical region associated with the first digital device or the consumer utilizing the first digital device/ The present systems and methods may determine a digital media content type of the geographically relevant local digital media and/or filter the geographically relevant local digital media based on the digital media content type of the geographically relevant local digital media and at least one of the first digital device or a third-party website.

The present systems and methods may distribute filtered geographically relevant local digital media content to the first digital device or the third-party website via the first digital communication network.

In embodiment, the digital media content type of the filtered geographically relevant local digital media content may be accessible or displayable via the first digital device or the third-party website.

In embodiment, the first digital device may be a portable digital device or a handheld digital device.

In embodiment, the present systems and methods may access the filtered geographically relevant local digital media content via the first digital device or the third-party website over the first digital communication system or a second digital communication system.

In embodiment, the present systems and methods may display the filtered geographically relevant local digital media content via the first digital device or the third-party website.

In embodiment, the present systems and methods may upload and store local digital media content in the database via a computer terminal or a second digital device connectable and in communication with the database.

In embodiment, the present systems and methods may embed a call for action feature in the filtered geographically relevant local digital media content.

In embodiment, the present systems and methods may conduct a discreet transaction between the consumer utilizing the first digital device and an author of the filtered geographically relevant local digital media content via the call for action feature associated with the filtered geographically relevant local digital media content.

In embodiment, the discreet transaction may relate to an enrollment, a subscription, a registration, a file download, a telephone call, a communication and/or a business transaction.

In another embodiment, the present systems and methods may distribute geographically relevant local digital media content to one or more digital devices over at least a first digital communication network. The present systems and methods may determine geographical relevance of local digital media content, with respect to a geographical region associated with a first digital device or associated with a consumer utilizing the first digital device, to identify geographically relevant local digital media content, wherein the geographically relevant local digital media content is geographically relevant with respect to the geographical region associated with the first digital device or the consumer utilizing the first digital device, wherein the local digital media content is stored in a database accessible via the first digital communication network. The present systems and methods may add a call for action feature to the geographically relevant local digital media content, distribute the geographically relevant local digital media content to the first digital device or a third-party website via the first digital communication network and/or may conduct a discreet transaction between the consumer utilizing the first digital device and an author of the geographically relevant local digital media content via the call for action feature.

In embodiment, the call for action feature may be a link embedded in the geographically relevant local digital media content.

In embodiment, the discreet transaction may relate to an enrollment, a subscription, a registration, a file download, a telephone call, a communication or a business transaction.

In embodiment, the present systems and methods may approve, select or activate the call for action feature to conduct the discreet transaction between the consumer and the author.

In embodiment, the present systems and methods may select a type of the call for action feature based on at least one of the geographically relevant local digital media content, the first digital device and the third-party website.

In embodiment, the present systems and methods may filter the geographically relevant local digital media content based on a digital media content type of the geographically relevant local digital media content.

In embodiment, the filtered geographically relevant local digital media content may be accessible or displayable via the first digital device or the third-party website.

In embodiment, the type of the call for action feature may be based on the digital media content type of the geographically relevant local digital media content.

In embodiment, the present systems and methods may distribute the filtered geographically relevant local digital media content to the first digital device or the third-party website via the first digital communication network or a second digital communication network.

In embodiment, the present systems and methods may upload the local digital media content to the database via a computer terminal or a second digital device connected to and/or in communication with the database.

In embodiment, the filtered geographically relevant local digital media content may be indicative of a local event, a local deal, a local special, a local offer, local news, a local image or picture, local business information, local information, local restaurant menus, local governmental agency news or events or local government news or events.

### BRIEF DESCRIPTION OF THE DRAWINGS

So that the features and advantages of the present disclosure can be understood in detail, a more particular description of the systems and methods may be had by reference to the embodiments thereof that are illustrated in the appended drawings. It is to be noted, however, that the appended drawings illustrate only some typical embodiments of the present systems and methods and are therefore not to be considered limiting of its scope, for the systems and methods may admit to other equally effective embodiments.

FIG. 1 is a flowchart showing how a consumers (consumer of content), enters their demographic information, selects content authors and how this information is stored on a local content management and/or distribution system in accordance with an embodiment.

FIG. 2 is a flowchart showing how a local content author enters their demographics, selects relative category strings and how this information is stored on a local content management and/or distribution system in accordance with an embodiment.

FIG. 3 is a flowchart showing how a local content author publishes and manages local content, and how the local content is categorized, organized and stored on a local content management and/or distribution system in accordance with an embodiment.

FIG. 4 is an extension of FIG. 3 and is a flowchart showing how a local content is distributed across the plurality of Internet media types by a local content management and/or distribution system in accordance with an embodiment.

FIG. 5 illustrates a block diagram of a local content management and/or distribution system in accordance with the present disclosure;

### DETAILED DESCRIPTION OF THE INVENTION

The present systems and methods may publish, manage and/or distribute local digital media content to one or more digital devices via one or more networks. The digital media content may be local content or local information (hereinafter “local content”) which may be relevant or substantially relevant to a geographical relevance associated with the local content. The local content may include information and/or data that determines, identifies and/or assigns the geographical relevance of the local content with respect to the one or more digital devices and/or one or more consumers using the one or more digital devices. The present systems and methods may filter the geographically relevant local content, before distributing to a consumer digital device or a third-party server, database or website, based on the type of digital media content of the local content. The filtering by the present systems and methods may be based on digital media content type requirements of the consumer digital device or the third-party server, database or website.

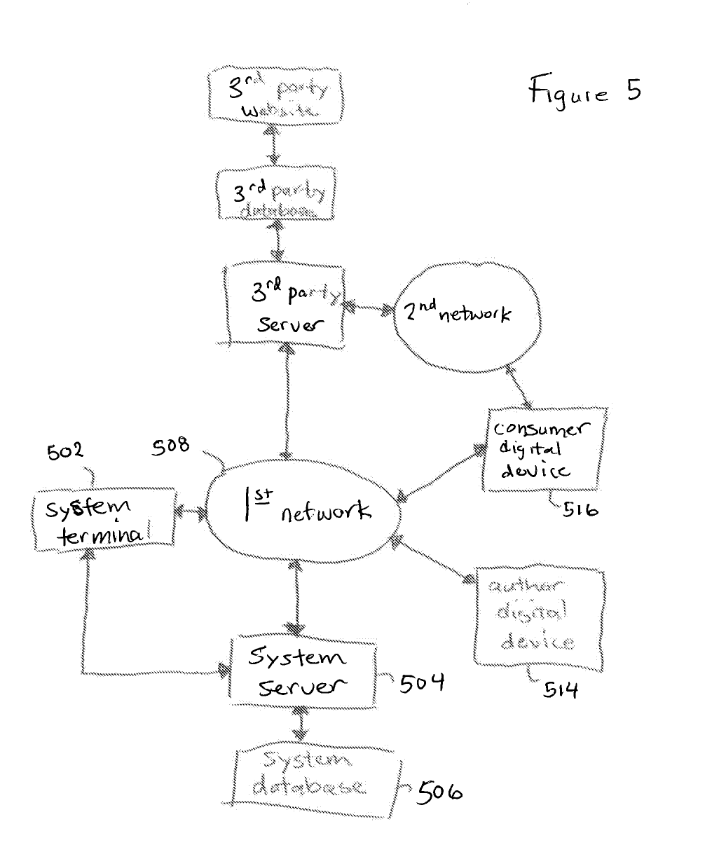

Referring now to the drawings wherein like numerals refer to like parts, FIG. 5 shows a digital local content management and/or distribution system 500 (hereinafter “system 500”) in accordance with an embodiment. The system 500 may have a system computer or terminal 502 (hereinafter “terminal 502”), a system server 504, a system database 506, a first digital communication network 508 (hereinafter “first network 508”), a third-party server 510, a third-party database 512, an author digital device 514 (hereinafter “author device 514”), a consumer digital device 516 (hereinafter “consumer device 516”), a second digital communication network 518 (hereinafter “second network 518”) or any combination thereof. The present disclosure should not be deemed as limited to a specific number of consumer devices, author devices, digital communication networks, third-party servers and/or third-party databases which may access and/or may utilize the system 500.

In embodiments, the author device 514 and/or the consumer device 516 (hereinafter “devices 514, 516”) may one or more portable digital devices, one or more handheld digital devices, one or more computer terminals or any combination thereof. In an embodiment, the devices 514, 516 may be wireless electronic media device, such as, for example, a tablet personal computer (hereinafter “PC”), an ultra-mobile PC, a mobile-based pocket PC, an electronic book computer, a laptop computer, a video game console, a digital projector, a digital television, a digital radio, a media player, a portable media device, a PDA, an enterprise digital assistant and/or the like. In an embodiment, the devices 514, 516 may be, for example, a hyper local digital device, location-based digital device, a GPS-based digital device, a 4G mobile device, a 3G mobile device, an ALL-IP electronic device, an information appliance or a personal communicator. The present disclosure should not be deemed as limited to a specific embodiment of the devices 514, 516.

Each of the devices 514, 516 may have a display for displaying or rendering information and/or multimedia data stored in a memory or at least one digital storage device of the devices 514, 516. In an embodiment, the displays of the devices 514, 516 may be a touch-screen graphic user interface (hereinafter “touch-screen GUI”) or a digitized screen connected to a microprocessor of the devices 514, 516. The device 512 may display or render selected information and/or the multimedia data to the user. The selected information and/or multimedia data may be one or more types of digital media content associated with the local content which may be stored in the system database 506 and/or the third-party database 512 and/or accessible via the system 500. The memory or at least one digital storage device of the devices 514, 516 may have stored thereon executable instructions, one or more computer programs and/or software that, when executed by at microprocessor of the devices 514, 516, perform one or more steps of the method for publishing, managing and/or distributing local content via the system 500 over the first network 508 and/or the second network 518 (hereinafter “networks 508, 518”).

In embodiments, the devices 514, 516 may have communication components for connecting to and/or communicating with the networks 508, 518. In an embodiment, the communication components of the devices 514, 516 may be a wireless transducer, such as, for example, a wireless sensor network device, such as, for example, a Wi-Fi network device, a wireless ZigBee device, an EnOcean device, an ultra-wideband device, a wireless Bluetooth device, a wireless Local Area Network (hereinafter LAN) accessing device, a wireless IrDA device and/or the like.

The devices 514, 516 may connect to and/or may access the first network 508 via the communication component of the devices 514, 516, respectively. The terminal 502, the system server 504, system database 506, the third-party server 510 and/or the third-party database 512 may be connected to the first network 508 and may be accessible by the devices 514, 516 via the first network 508. As a result, the devices 514, 516 may be in communication with the terminal 502, the system server 504, system database 506, the third-party server 510 and/or the third-party database 512 of the system 500 and may access information, data and/or digital media content, such as, for example, local content stored therein. In embodiments, the devices 514, 516 may establish a secured wireless connection to the terminal 502, the system server 504, system database 506, the third-party server 510 and/or the third-party database 512 via the first network 508. In an embodiment, the consumer device 516 may connect to and/or be in communication with the third-party server 510 and/or the third-party database 512 via the second communication network 518.

In embodiments, the networks 508, 518 may be, for example, a personal area network (PAN), a local area network (LAN), a campus area network (CAN), a Metropolitan area network (MAN), a wide area network (WAN) and/or the like. In an embodiment, the networks 508, 518 may be a wireless network, such as, for example, a wireless MAN, a wireless LAN, a wireless PAN, a Wi-Fi network, a WiMAX network, a global standard network, a personal communication system network, a pager-based service network, a general packet radio service, a universal mobile telephone service network, a radio access network and/or the like. In an embodiment, the networks 508, 518 may be a fixed network, such as, for example, an optical fiber network, an Ethernet, a cabled network, a permanent network, a power line communication network and/or the like. In another embodiment, the networks 508, 518 may be a temporary network, such as, for example, a modem network, a null modem network and/or the like. In yet another embodiment, the networks 508, 518 may be an intranet, extranet or the Internet which may also include the world wide web. The present disclosure should not be limited to a specific embodiment of the networks 508, 518.

### Consumers/Readers

The present systems and method may provide users, consumers and/or readers (hereinafter “consumers”) with control or substantial control over their digital media content intake via one or more digital devices, such as, for example, the consumer device 518 over, for example, the Internet or a telecommunication network, such as, for example, the networks 508, 518. To ensure that consumers get only the relevant local content they desire, each consumer is able to define the content category strings, types and/or specific authors/owners (hereinafter “authors”) of the content they want.

Category strings are defined as an up to three (3) level categorization system having a category, and possibly; its subcategories; and its subcategories, tertiary categories. Within each local content category string consumers are able to further refine their selection to obtain more precise local content delivery. In addition to consumers defined data, the present systems and methods automatically assign/incorporate additional filtering, and content selection processes based upon a consumer's demographics, historical use, projected use and geographical data. The geographical data may be indicative of a geographical location of the consumer and/or the consumer device 516. The geographical relevance of the local content may be determined by and/or based on the geographical data and/or the geographical location of the consumer and/or the consumer device 516.

Consumers can also select types of digital media content that are more generic, yet still filtered and sorted according to their specific needs.

Consumers can also choose to subscribe to specific authors of local content. Once a consumers has subscribed to a specific author, all local content provided by that author will be automatically delivered and/or distributed to the consumers via the consumer device 518 and can be further filtered by their consumers-defined preferences, or not. Consumers can subscribe and unsubscribe to an author at will.

The majority of consumer's defined local content is viewed via, for example, a consumer's personal portal/dashboard or the consumer device 518, yet at any time can be viewed using a location and category-based interface that may take into consideration their consumers-defined preferences. At any time, a consumer may change their preference settings. In addition to the World Wide Web delivery interfaces, other Internet and World Wide Web delivery media/mechanisms/systems will be used, such as: e-mail, SMS, printable daily content manifests, mobile e-mail, mobile web, etc.

In embodiments, the local content, which is geographical relevant to one or more consumers, may be stored in the system terminal 502, the system database 506 and/or third-party server 510. After, local content may be determined to be geographically relevant to the consumer, the system 500 may be configured and/or adapted to automatically distribute the local content to the consumer device 516 via the networks 508, 518. In an embodiment, the terminal 502, the system server 504 and/or the third-party server 510 may have at least one storage device having stored thereon executable instructions, one or more computer programs and/or software that, when executed by at least one processor, perform the method of publishing, managing and/or distributing the local content to the consumer device 516. For example, at least one processor associated with the terminal 502, the system server 504 and/or the third-party server 510 may execute one or more computer programs and/or software that automatically distributes the local content to the consumer device 516 upon determining that the local content is geographically relevant to the consumer and/or the consumer device 516.

In embodiments, the local content may be geographically relevant to a geographical region associated with the consumer and/or the consumer device 516. For example, the geographical region associated with the consumer and/or the consumer device 516 may be defined by a street address, a mailing address, a home address, an employment address, a temporary mailing address, post office box, a post office, a zip code, a village, a town, a city, a metropolis, a region, a state, a commonwealth, a territory, a nation, a country, a continent, a hemisphere or a combination thereof. For example, the local content may geographically relevant to consumers located within a region and the system 500 may be configured and/or adapted to automatically distribute the local content to all consumers within the region via consumer devices upon determining the geographical relevance of the local content.

In embodiments, the local content may be and/or may provide at least one local item of interest that may be geographically relevant to the geographical region associated with the consumer and/or the consumer device 516. For example, at least one local item of interest may include local events, local deals, local specials, local offers, local news, local images, local pictures, local business information, local restaurant menus, local police news and/or events, local government news and/or events or a combination thereof. As a result, the system 500 may automatically distribute the local content to the consumer device 516 upon determining that at least one local item of interest may be geographically relevant to the geographical region associated with the consumer and/or the consumer device 516.

In embodiments, the local content may include and/or may be digital data and/or digital information that relates to journalism, education, professional training, science, engineering, digital art, digital photography, digital music, digital video, virtual reality, augmented reality, entertainment, movies, music, television, video games, government, military, nonprofit services or a combination thereof. In other embodiments, the digital data and/or digital information may relate to marketing, advertising, digital signage, graphic design, communications, transportation, public services or combinations thereof. In an embodiment, the local content may relate to local marketing, social marketing, email marketing, online marketing, transactional marketing, content widgets or combinations thereof and/or the author of the local content may be a local business, a franchise, a publisher, a brand, a manufacturer, a distributor, a government agency or a commercial entity. As a result, the system 500 may be a local marketing system configured and/or adapted to market local businesses that serve a local market that may be geographically relevant to the geographical location of the consumer and/or the consumer device 516.

The geographically relevant local content may be published, delivered and/or distributed to the consumer device 516 in one or more different digital media types. The one or more different digital media types may include email, social network media, blogs, websites, digital applications, downloadable applications, SMS, file sharing websites, RSS feeds, online directories, digital event calendars, online search engines, online local media providers, such as, for examples, online newspapers and/or online publishers. In an embodiment, the local content may be, may contain or may include one or more media files, such as, for example, Advanced Systems Format files (.asf), Windows Media Audio files (.wma), Windows Media Video files (.wmv), MP3 files (.mp3), JPEG files (.jpeg or .jpg), Multicast information files (.nsc), Client-side playlist files (.asx, .wax, and .wvx) or Server-side playlist files (.wsx).

The one or more different digital media types for the local content that may be distributed to the consumer device 516 may be determined by the system 500 based on which type of digital device being utilized by the consumer. Some digital media types may be more preferred for distribution by the system 500 based on the type of digital device that is being utilized by the consumer. For example, hyper local media, such as, for example, blogs and websites may be distributed to hyper local digital devices via the system 500, mobile media, such as, for example, downloadable application communications and SMS may be distributed to digital mobile devices via the system 500, and location-based or GPS-based media may be distributed to location-based or GPS-based media via the system 500.

The present systems and methods may be configured and/or adapted to provide authors with the ability to control the local content at the point of entry. The local content author may provide, to the system 500, demographic, geographic and local information for the local content to facilitate the standardizing and organizing of all digital media content by the author via the author device 514. The system 500 may be configured and/or adapted to utilize the demographic, geographic and local information to determine geographical relevance of the local content with respect to the geographical region associated with the consumer and/or the consumer device 516. If the system 500 determines that geographical relevance exists between the local content and geographical region associated with the consumer and/or the consumer device 516, the system 500 automatically publishes and/or distributes the local content to the consumer device 516 via the networks 508, 518 and/or to the third-party server 510 and the third-party database 512. As a result, the system 500 may facilitate automatic and/or accurate publishing and/or delivery of the geographical relevant local content to one or more consumers and/or the consumer device 516 and/or the third-party server 510 and the third-party database 512. In addition to author provided data, the present systems and methods may assign and/or incorporate additional filtering, standardization and organization algorithms, based upon a local digital media content author's historical use, projected use and accepted industry specific practices.

The local content of one or more authors may be uploaded to the system 500 via the author device 514 and/or the terminal 502. As a result, the local content of one or more authors may be stored in the terminal 502, the system database 506 and/or the third-party server 510. For example, the author may upload the local content via the author device 514 and/or store the uploaded local content in the system database 514, and/or in digital storage device associated with the terminal 502 through, for example, a web interface, third party content management interface and/or programmable data exchange interface over the first network 508. In an embodiment, the author may directly upload local content to the system server 504 and/or store local content in the system database 506 via the system terminal 502.

The entry point of the local content may be configured and/or adapted to perform filtering, standardizing and/or organizing of the local content. The entry point provides key data about the source, digital media content type and/or category of the local content based upon predetermined descriptive data that is assigned to the local content and/or the entry point which may be the author device 514 or the terminal 502.

### Distributing Local Content

The present systems and methods may be configured and/or adapted to automatically and/or accurately publish and/or deliver geographically relevant local content to one or more consumers who may want the content in a manner that is convenient to them and self determined.

The present systems and methods may filter local content uploaded by one or more authors based on the type of digital media content of the local content. The filtering of the local content by the present systems and methods may be based on the geographical relevance of the local content and/or a type of digital media content of the local content which may be an acceptable and/or displayable digital media content type for the consumer device 516, the third-party server 510 and third-party database 512 and/or a third-party website 520. The third-party website 520 may be stored in the third-party database 512 and/or may be accessible by the consumer device 518 via the third-party server 510 and/or the networks 508, 518.

In an embodiment, the system 500 may be configured and/or adapted to determine or identify one or more digital media types which may be acceptable and/or displayable by the consumer device 516 and/or the third-party server 510, database 512 and/or website 520. An acceptable and/or displayable digital media type(s) may be based on one or more technical requirements associated the networks 508, 518, the consumer device 516 and/or the third-party website 520. The acceptable and/or displayable digital media type(s) may be based on the digital device type of the consumer device 516.

The present systems and methods may filter the local content uploaded by the one or more authors based on the acceptable and/or displayable digital media type(s) for the consumer device 516 and/or the third-party server 510, database 512 and/or website 520. The system 500 may be configured and/or adapted to publish and/or distribute filtered local content to the consumer device 516, the third-party server 510, the third-party database 512 and/or the third-party website 520. In an embodiment, the filtered local content may be (i) geographically relevant with respect to the geographical region associated with the consumer and/or the consumer device 516 and/or (ii) acceptable and/or displayable by the consumer device 516 and/or the third-party server 510, the database 512 and/or the website 520.

For example, the consumer device 516 and/or the third-party website 520 may be configured and/or adapted to receive, store, access and/or display digital multimedia content, such as, for example, digital photographs and/or digital videos. The present systems and methods identify and/or determine that the consumer device 516 and/or the third-party website 520 are capable of receiving, storing, accessing and/or displaying digital multimedia content. From the local content uploaded by the one or more authors, the system 500 may determine which local content is geographically relevant with respect to the geographical region associated with the consumer and/or the consumer device 516. The system 500 filters the geographically relevant local content based on the digital media type(s) of the geographically relevant local content such that the filtered local content includes local content that may be digital multimedia content. The system 500 publishes and/or distributes the filtered geographically relevant local content to the consumer device 516 and/or the third-party server 510, database 512 and/or website 520 via the networks 508, 518. The filtered geographically relevant local content may be received, stored, accessed and/or displayed via the consumer device 516 and/or the third-party server 510, the database 512 and/or the website 520. As a result, a consumer may access and/or view the filtered geographically relevant local content via the consumer device 516 and/or the third-party website 520.

In an embodiment, the present systems and methods may format and/or convert local content uploaded by the one or more authors to be in one or more acceptable and/or displayable digital media types for the consumer device 516 and/or the third-party server 510, the database 512 and/or the website 520. The system 500 may be configured and/or adapted to publish or distribute formatted or converted local content to the consumer device 516 and/or the third-party server 510, the database 512 and/or website 520. The formatted or converted local content may be (i) geographically relevant with respect to the geographical region associated with the consumer and/or the consumer device 516 (ii) acceptable and/or displayable by the consumer device 516 and/or the third-party server 510, the database 512 and/or the website 520.

In embodiments, the system 500 may be configured and/or adapted to determine (i) which digital media type(s) may be preferred by the consumer or the consumer device 516 based on prior-use history for the consumer or the consumer device 516 or (ii) which digital media type(s) may more easily accessible by the consumer device 516 based on prior consumer use history. As a result, the system 500 may determine a preferred digital media type for the consumer and/or the consumer device 500. Once the preferred digital media type is determined by the system 500, the system 500 may publish and/or distribute geographically relevant local content, formatted in the preferred digital media type, to the consumer device 516 and/or the third-party server 510, the database 512 and/or the website 520. As a result, geographically relevant local content, formatted in the preferred digital media type, may be received, stored, accessed and/or displayed via the consumer device 516 and/or the third-party server 510, the database 512 and/or the website 520 over the networks 508, 518.

In another embodiment, the preferred digital media type for distributing the local media to the consumer device 516 may be determined and/or based on an access method that may be utilized by the consumer to access the local media on the consumer device.

### Publishing and Management of Local Content

The delivery method may have one or more unique distribution paths, yet is not limited to any of the follow paths:

Consumers may be provided an interface via the World Wide Web in the form of a personal portal/dashboard to receive the content that they have defined as relevant. The personal portal/dashboard may be organized by local content master categories. Within each category, consumers may further define the content they desire. Additional consumers interface facilitation tools may be provided to make sorting, displaying and overall look and feel, personally beneficial and relevant to each specific consumers.

Local content may be delivered to consumers, via daily digest on several other Internet delivery methods such as e-mail, SMS, mobile e-mail, mobile web, etc., and via daily manifests. Daily digests may be an encapsulation and/or brief description of all the newest daily content that is on a consumer's personal portal/dashboard. A Daily manifest may be a format that allows the consumers to read the local content that may be available via their personal portal/dashboard in its entirety, on paper, offline or other portable digital reading devices, such as, consumer devise 516.

Local content author/owner/provider can have their own web site automatically updated and/or fully deployed with the local content that they provide the present systems and methods via a programmable data exchange interface. The one or more authors can either have, parts of their local content updated on their website or have their entire website's content, navigation, format, etc. published, deployed, managed, and/or updated by the present systems and methods.

Local content in the present systems and methods may also be made readily available for search engine indexing. The present systems and methods may add additional content that is specifically designed to provide better indexing for search engines and their automated indexing process. The local content that may be added to the original local content varies based upon the multitude of search engines and their ever changing search algorithms.

The present systems and methods may also be integrated via programmable data exchange interface to licensed third-party providers of content to further promote and distribute local content.

The present systems and methods may be configured and/or adapted to facilitate the gathering, publishing, managing, promoting and distributing of local content. The present systems and methods may be configured and/or adapted to provide a place for a provider, author and/or owner of local content to properly control and benefit from it across the plurality of different digital media types.

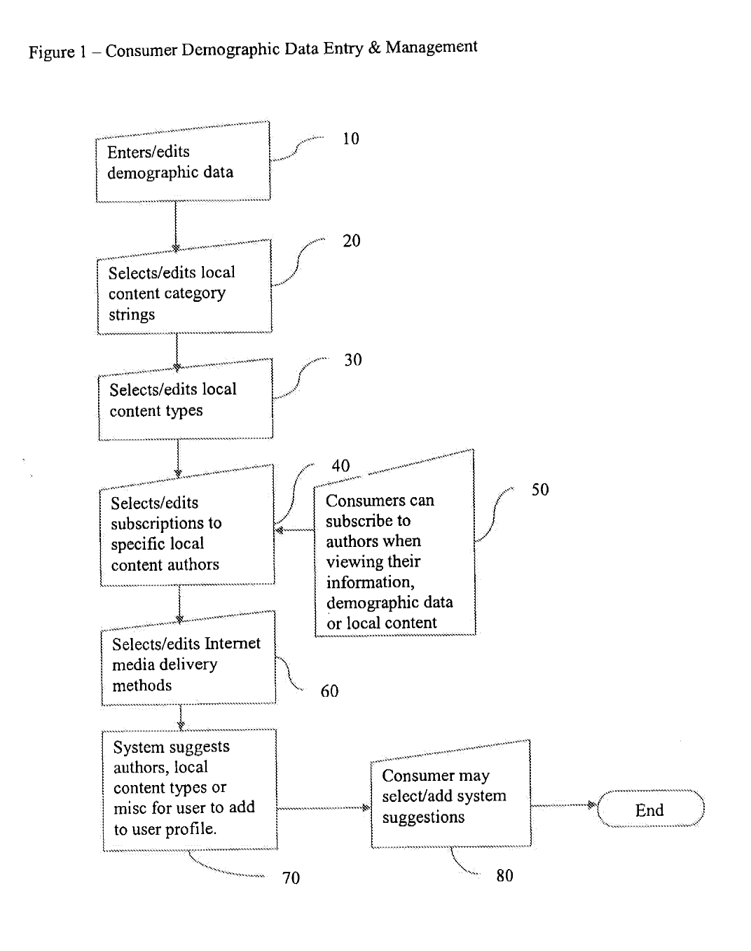

As represented by reference numeral 10 in FIG. 1 a consumer, i.e., a consumer of local content, may enter into the system 500, their demographic and/or geographic information. Inputted content preferably may include information concerning their home and/or work geographical locations, age, gender and other standard demographical information. At step 20 the consumer may select or edit existing/suggested local content category strings they feel may be relative to the local content they may desire now and in the future. At step 30 the consumer may select or edit existing local content types and their corresponding sub-types that they feel are relative to the content types they desire now and in the future. i.e. “events—kids” which may refer to events specifically targeted towards kids. At step 40 the consumer may be presented with the option of searching for specific local content authors that they would like to receive local content from. The system 500 may provide several means to select local content authors such as, key word, content type and/or author name.

At step 50 in a separate process within the system 500, the consumer may add a specific author as they are reading their local content by clicking on a button or hyperlink that may allow them to automatically update the consumer's demographics data accordingly. At step 60 the consumer may select the digital media delivery method they wish to have their local content delivered to from the system 5001.e. email, SMS, Personal Portal web page, etc. At step 70 the system 500 may suggest authors, content types and/or category strings that are relative to the consumer's previous data entry based upon a system algorithm storable and/or accessible via the terminal 502, the author device 514, the consumer device 516, a third-party computer terminal (not shown in the drawings), another computer terminal connectible to the system 500 or combinations thereof. At step 80 consumers may choose to select or not the suggestions of the system 500 and then may submit the demographic data to be stored on the system. The consumers demographics profile entry or edit process may be completed.

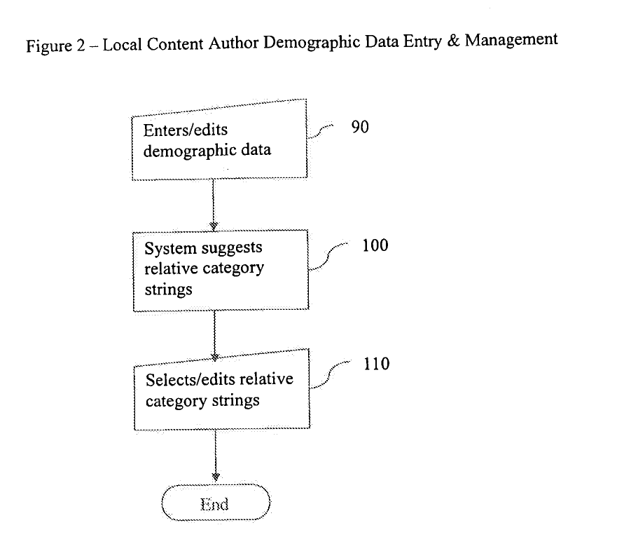

Referring to FIG. 2, at step 90 the local content author (LCA) may enter demographic data. Such data typically may include their location, products, services and general demographic information. At step 100, the system 500 may suggest relative category strings based upon the demographic data entered. The system 500 may make suggestions typically based upon keywords and phrases that may be associated with the category strings as related to the demographic data as entered by the LCA. At step 110, the LCA may select or edit the system's suggestions for category strings to be associated with their demographics profile. The local content author demographics profile entry or edit process may be completed.

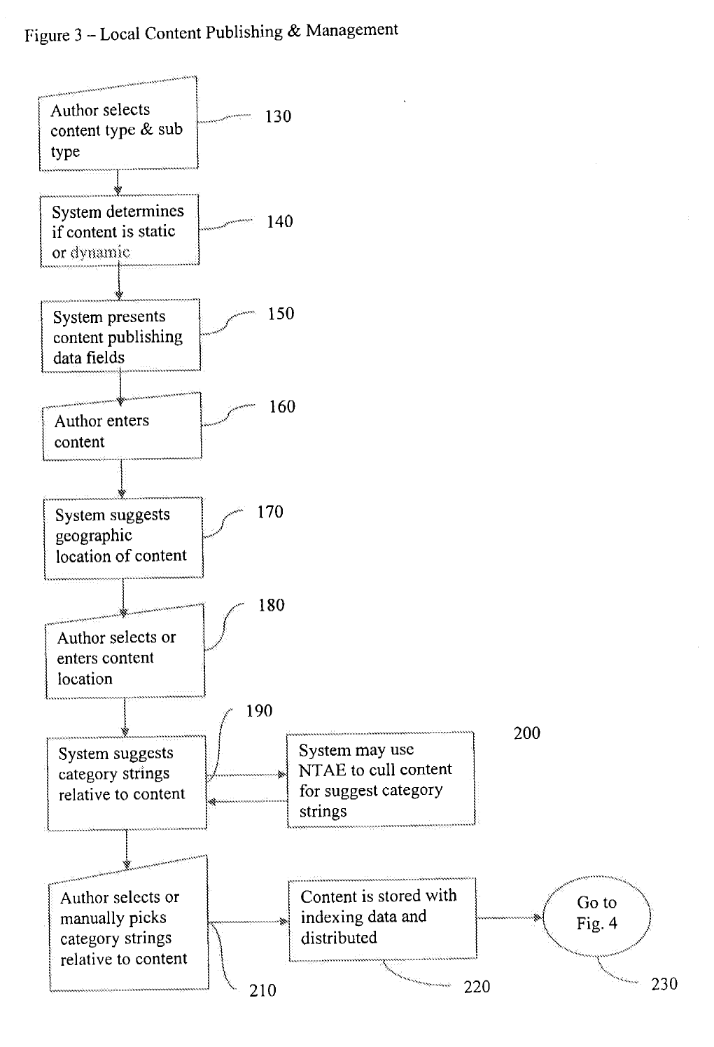

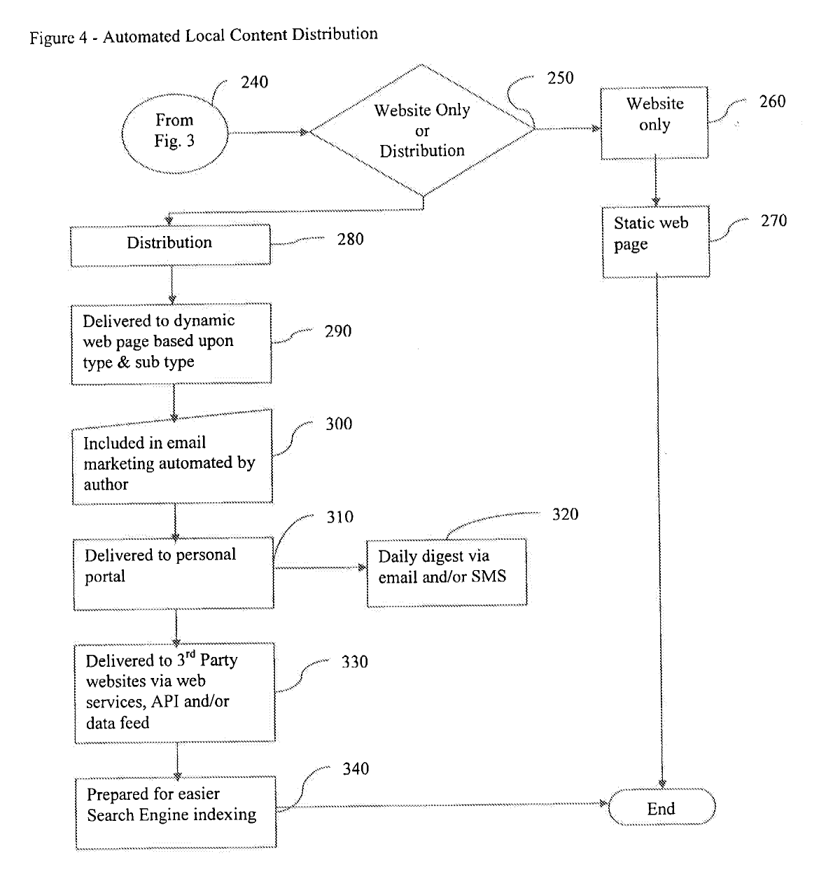

Referring to FIG. 3, at step 130 the LCA may select the content type and may also select a related sub type. At step 140 the system 500, based upon the content type, may determine if the content is a static web page or dynamic content. At step, 150 the system 500 may present the appropriate data fields relative to the content type. For example, if the content type may be, for example, a news article, the data fields for news content may be presented for input by the LCA. At step 160 the LCA may enter the appropriate local content. At step 170, the system 500 may suggest the location relevance of the local content and may provide the option for the LCA to either select the suggestion or enter a new location. The location may be the geographical region associated with the consumer and/or the consumer device 516 or may be generally zip code based and either town, county, region, state or country specific in its scope (radius) of the LCA and/or local content location relevance. At step 180 the LCA may either accept the system suggested geographical region or location or may enter a new geographical region, and then may select the scope (radius) of the geographical region. At step 190 the system 500 may suggest one or more category strings relative to the content and/or LCA's demographic data and/or the geographical region associated with the consumer and/or the consumer device 516. At step 200, the system 500 may to suggest relative categories. At step 210, the LCA may select or manually determine the category strings relative to the local content. At step 220, the local content along with the associated category strings and indexing data for the local content may be stored. At step 230 the process is continued on FIG. 4.

Referring to FIG. 4, at step 240, the system 500, which may be based upon the content type, may take at least two separate paths. At step 250, the system 500 may proceed to step 260 if the content may be intended only for publishing on the LCA's website. At step 270, the local content may be published on the LCA's website in the form of a static web page along with indexing data that may be useful for search engine optimization. The process for publishing local content in the form of a static web page may be completed.

Returning to FIG. 4, at step 250 for a second option, when the system 500 may be presented a content type that is dynamic and intended for distribution it may proceed to step 280 to start the automated distribution process. At step 290, the local content may be published on the LCA's website in the form of a dynamic web page with the data being delivered from at least one of the system database 506 and the third-party database 512. At step 300, the system 500 may present the local content to be included in an email. The local content may be selected by the LCA at anytime for inclusion into the email. At step 310, the local content may be delivered to the consumer device 516 or to a consumer's personal portal generally when the following criteria may been met; a) the consumers has preselected the content's type, sub type and/or location scope, b) the consumers has subscribed to the LCA for delivery of their local content or c) it's criteria matches that of other various content filters that the consumer or the system 500 has determined desirable to receive. At step 320, the consumer may have selected to have been notified via email or SMS for example that new local content may be available for review.

At step 330, the third-party website 520 may publish and/or deliver the local content that may be included on their website(s) via web services, data feed or API (application program interface) generally when the following criteria has been met; a) the third-party website 520 or consumer device 516 may have preselected the content's type, sub type and/or location scope, b) the third-party website 520 or consumer device 516 may have subscribed to the LCA for delivery of their local content or c) criteria of the local content may match that of other various content filters that the third-party website 520 or consumer device 516 may have determined desirable to receive. At step 340, the system 500 may index the local content and/or may add specific location, category string and various other meta data to prepare the local content for easier search engine optimization. The process of automated distribution may be completed.

In embodiments, the present systems and methods embed, incorporate, include and/or insert one or more call for action features into the local content uploaded by the one or more authors. The system 500 may embed, incorporate, include and/or insert the one or more call for action features into the local content which may be stored in system server 504 and/or the third-party database 512 and/or accessible and/or viewable via the consumer device 516 and/or the third-party website 520 over the networks 508, 518. As a result, the one or more call for action features of the local content may be accessible, viewable and/or executable by the customer when the customer may be viewing and/or displaying the local content via the consumer device 516 and/or the third-party website 520. A type(s) of the one or more call for action features may be based on, indicative of and/or determined by the digital media content type(s) of the local content, by the one or more authors of the local content, by the digital device type of the consumer device 516, and/or the third-party website 520.

The one or more call for action features embedded, incorporated, included and/or inserted into the local content may be configured and/or adapted to create, offer and/or complete one or more discreet transactions associated with the local content which may be accessible by the customer via the customer device 516 and/or the third-party website 520 over the networks 508, 518. In an embodiment, the system 500 may enact, conclude, settle, manage and/or negotiate the one or more discreet transactions between the consumer and the one or more authors of the local content via the one or more call for action features of the local content. As result, the one or more discreet transactions between the consumer and the one or more authors of the local created, offered, enacted, concluded, settled, managed, negotiated and/or completed via the one or more call for action features of the local content.

In an embodiment, the one or more call for action features may be one or more actionable hyperlinks (hereinafter “link”) which may be configured and/or adapted to allow, permit and/or facilitate displaying and/or activating one or more digital documents, local content and/or computer programs. For example, the local content, which may be related to and/or indicative of a local event conducted by the author of the local event and may include the link, may be accessed and/or displayed by the consumer via the consumer device 516 and/or the third-party website 520. The consumer may select, activate and/or open the link embedded in the local content which may configured and/or adapted to allow the consumer to register for attending the event conducted by the author. In embodiment, selecting, activating and/or opening the link of the local content may activate and/or open another website and/or webpage which may be, for example, an event registration webpage for the event conducted by the author. In order to complete the discreet transaction, such as, for example, registration for attending the event of the author of the local content, the customer may access the event registration webpage via the link and complete one or more necessary tasks which are required to complete and/or confirm registration for the event conducted by the author of the local content.

In an embodiment, the local content, accessed and/or displayed by the consumer device 516 and/or the third-party website 520 may be, for example, product marketing and/or advertizing for one or more products and/or one or more services offered by the author of the local content. The link of the local content may configured and/or adapted to provide an offer to the customer for purchasing, buying and/or receiving the one or more products and/or one or more services of the author of the local content. The link, when selected and/or activated by the consumer, may, for example, open, activate and/or display a buy/purchase website which may be configured and/or adapted to complete one or more business transactions between the consumer and author for one or more products and/or services of the author of the local content. In order to complete the business transaction between the consumer and the author, the consumer may complete one or more steps provided by the buy/purchase website and/or may provide and/or input information into the buy/purchase website via the consumer device 516 and/or the third-party website 520. After the one or more steps may be completed by the consumer and/or the information may be provided and/or inputted by the consumer, the business transaction between the consumer and the author may be completed. As a result, the one or more products of the author may be delivered and/or shipped to the customer and/or the one or more services of the author may be rendered to the customer.

In embodiments, the one or more discreet transactions which may be created, offered, enacted, concluded, settled, managed, negotiated and/or completed may include and/or relate to one or more financial transactions, business transactions, retail transactions, real estate transactions, personal property transactions, information transactions, non-financial transactions and/or combinations thereof. For examples, the one or more discreet transactions may be and/or relate to one or more event registrations, product purchase transactions, service purchase transactions, subscription enrollments, newsletter enrollments, e-mail newsletter enrollments, catalog enrollments, brochure requests, information requests, telephonic response requests, financial payments, requests for estimates and/or bids, insurance estimates, health and/or medical information requests and/or combinations thereof. In an embodiment, the local content, the one or more call for action features, the one or more discreet transactions, and/or the one or more hyperlinks embedded within the local content may be utilized by the present system and methods to perform, conduct and/or facilitate local marketing, social marketing, email marketing, online marketing, transactionable marketing and/or any combination thereof.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

1. A method for distributing geographically relevant local digital media content to one or more digital devices over at least a first digital communication network, the method comprising:
providing a local digital media content distribution system comprising at least a first digital device and a database connected to and in communication with each other via the first digital communication network, wherein local digital media content is stored within the database;
determining geographical relevance of the local digital media content, with respect to a geographical region associated with the first digital device and/or associated with a consumer utilizing the first digital device, to identify geographically relevant local digital media content, wherein the geographically relevant local digital media content is geographically relevant with respect to the geographical region associated with the first digital device or the consumer utilizing the first digital device;
determining a digital media content type of the geographically relevant local digital media;
filtering the geographically relevant local digital media based on the digital media content type of the geographically relevant local digital media and at least one of the first digital device or a third-party website; and
distributing filtered geographically relevant local digital media content to the first digital device or the third-party website via the first digital communication network.

2. The method according to claim 1, wherein the digital media content type of the filtered geographically relevant local digital media content is accessible or displayable via the first digital device or the third-party website.

3. The method according to claim 1, wherein the first digital device is a portable digital device or a handheld digital device.

4. The method according to claim 1, further comprising:
accessing the filtered geographically relevant local digital media content via the first digital device or the third-party website over the first digital communication system or a second digital communication system.

5. The method according to claim 4, further comprising:
displaying the filtered geographically relevant local digital media content via the first digital device or the third-party website.

6. The method according to claim 1, further comprising:
uploading and storing local digital media content in the database via a computer terminal or a second digital device connectable and in communication with the database.

7. The method according to claim 1, further comprising:
embedding a call for action feature in the filtered geographically relevant local digital media content.

8. The method according to claim 1, further comprising:
conducting a discreet transaction between the consumer utilizing the first digital device and an author of the filtered geographically relevant local digital media content via the call for action feature associated with the filtered geographically relevant local digital media content.

9. The method according to claim 8, wherein the discreet transaction relates to an enrollment, subscription, registration, a file download, a telephone call, a communication or a business transaction.

10. A method for distributing geographically relevant local digital media content to one or more digital devices over at least a first digital communication network, the method comprising:
determining geographical relevance of local digital media content, with respect to a geographical region associated with a first digital device or associated with a consumer utilizing the first digital device, to identify geographically relevant local digital media content, wherein the geographically relevant local digital media content is geographically relevant with respect to the geographical region associated with the first digital device or the consumer utilizing the first digital device, wherein the local digital media content is stored in a database accessible via the first digital communication network;
adding a call for action feature to the geographically relevant local digital media content;
distributing the geographically relevant local digital media content to the first digital device or a third-party website via the first digital communication network; and
conducting a discreet transaction between the consumer utilizing the first digital device and an author of the geographically relevant local digital media content via the call for action feature.

11. The method according to claim 10, wherein the call for action feature is a link embedded in the geographically relevant local digital media content.

12. The method according to claim 10, wherein the discreet transaction relates to an enrollment, a subscription, a registration, a file download, a telephone call, a communication or a business transaction.

13. The method according to claim 10, further comprising:
approving, selecting or activating the call for action feature to conduct the discreet transaction between the consumer and the author.

14. The method according to claim 10, further comprising:
selecting a type of the call for action feature based on at least one of the geographically relevant local digital media content, the first digital device and the third-party website.

15. The method according to claim 10, further comprising:
filtering the geographically relevant local digital media content based on a digital media content type of the geographically relevant local digital media content.

16. The method according to claim 15, wherein the filtered geographically relevant local digital media content is accessible or displayable via the first digital device or the third-party website.

17. The method according to claim 15, wherein the type of the call for action feature is based on the digital media content type of the geographically relevant local digital media content.

18. The method according to claim 15, further comprising:
distributing the filtered geographically relevant local digital media content to the first digital device or the third-party website via the first digital communication network or a second digital communication network.

19. The method according to claim 10, further comprising:
uploading the local digital media content to the database via a computer terminal or a second digital device connected to and/or in communication with the database.

20. The method according to claim 1, wherein the filtered geographically relevant local digital media content is indicative of a local event, a local deal, a local special, a local offer, local news, a local image or picture, local business information, local information, local restaurant menus, local governmental agency news or events or local government news or events.
